(19) United States
(12) Patent Application Publication
(10) Pub. No.: US 2023/0029684 A1
(43) Pub. Date: Feb. 2, 2023

(54) System and Method of Accounting Excluding Debit and Credit Designation

(71) Applicant: Lana Sami Nino, Orange, CA (US)

(72) Inventor: Lana Sami Nino, Orange, CA (US)

(21) Appl. No.: 17/955,824

(22) Filed: Sep. 29, 2022

Related U.S. Application Data
(63) Continuation-in-part of application No. 16/842,299, filed on Apr. 7, 2020, now abandoned.
(60) Provisional application No. 62/830,593, filed on Apr. 8, 2019.

(51) Int. Cl. G06Q 40/00

(52) U.S. Cl. CPC G06Q 40/12

(57) ABSTRACT

A system and method of accounting using an Expanded Normal Equation (ENE) is provided. The system and method utilize two equations of accounting and derives the ENE in order to reflect the dynamic relationship between all accounts. The associated method is implementable via an application executed through several technologies, including an electronic device and network. The application further provides for the reporting and the creation of financial statements. The system also provides a computer platform for using the ENE. The computer platform utilizes a smart node to generate information from a data file and data file profile to characterize transactions into categories. The categories are associated with a Chart of Accounts. The transactions are interpreted based on an equation referred to later as the ENE. The computer platform can also generate a list of reconciling possibilities that are sorted in the most relevant order, should an issue be identified.

### CROSS REFERENCE TO RELATED APPLICATION

This application claims the benefit of pending U.S. Provisional Application No. 62/830,593 filed on Apr. 8, 2019, and pending U.S. Nonprovisional application Ser. No. 16/842,299 filed on Apr. 7, 2020; the above identified patent application is herein incorporated by reference in its entirety.

### BACKGROUND OF THE INVENTION

The present invention relates to an accounting method and application. The present invention more specifically relates to an accounting method using an Expanded Normal Equation and the system and method being implemented on an electronic device.

Making accounting more accessible for business and non-business professionals is a worthy mission to improve stakeholders' understanding of financial information, which is a key element of understanding any business. The ability to understand how financial statements are constructed and the ability to read financial statements will improve the shared common language across departments and employees, helping them pursue the shared goals of an organization.

The present approach for accounting education has been a historical challenge, and one that educators struggle with and tried to propose different teaching methods for, in order to improve students' comprehension. Accounting is traditionally taught starting with the explanation of the five categories of accounts: Assets, Liabilities, Owners' Equity, Revenues and Expenses. The next step that follows is showing students how to prepare journal entries after explaining the debit and the credit side of the accounts. Although these tasks are well documented and explained, this is the phase where prior research shows that students have most difficulty. Research also shows that early negative experiences may lead to increased attrition and negative perceptions about the discipline. This suggests that accounting instructors may benefit from pedagogical intuition, when teaching journal entry accounting.

The present invention provides a system and method for allowing a user, such as an accounting instructor, to teach financial accounting to a class of non-accountants, using the Expanded Normal Equation approach and bridging the learning of accounting information, without the challenge of using debits and credits. Moreover, the present invention provides for allowing an accountant to input transaction information associated with accounts to generate financial reports. Second, accounting instructors can assist learners in connecting gaps of problem solving that may not available, if not for this technique. Further, the present invention allows for non-professional user's to perform accounting methods and execute financial reports without the need to seek professional assistance.

Accounting classifies accounts into five basic categories: assets, liabilities, equity, revenues and expenses. The accounts are compiled in the trial balance, which is a list of account balances, displayed in the same order as the categories above. There is known two accounting equations: the Basic Accounting Equation and the Income Statement Equadon. The Basic Accounting Equation presents the Permanent Accounts as follows: “Assets=Labilities+Owners' Equity.” This can be rewritten as “Assets−(minus) Liabilities=Owners' Equity.” The known Income Statement Equation (Temporary Accounts Used for Tracking Activity) is “Revenues−Expenses=Net Income.” An explanation of this is that monthly income minus monthly expenses results into a left-over amount traditionally called Net Income.

The relationship between the BasicAccounting Equation and the Income Statement Equation is that the temporary accounts (Revenues and Expenses) get closed out monthly and the net income is added into owner's equity. Another explanation of this relationship is that in order to keep the permanent equation in balance, the left-over amount, Net Income, is added into assets and equity, although this may not happen at the same time chronologically since the closing happens at the end of the period, while the revenues and expenses get recorded throughout the month. The method of the present invention combines the two equations into one in order to reflect the dynamic relationship between all accounts. Another way of expressing this in a business is that the permanent and temporary accounts are linked dynamically and there is no need to separate the equation, except for reporting and the creation of financial statements.

Traditional textbooks use the expanded equation of accounting as follows: “Assets=Liabilities+((Owners' Equity+(Revenues−Expenses)−Distributions to Stockholders)).” As persons and companies continue their business activities, their assets and liabilities continue to change. This is reflected in the monthly activity of additional revenues and expenses. The net of this monthly activity posts into the permanent accounts: Assets, Lability, and Equity.

Mathematically this expression can be simplified to the following (assuming no distributions, since they will be handled later as a contra-equity category), taking the parentheticals out. Note, the following assumes no contra accounts such as dividends: “Assets=Liabilities+Owners' Equity+Revenues−Expenses.”

Moreover, many accounting software applications that run on electronic devices do not follow typical accounting practices and require the user to track the journal entries. For example, many current accounting software requires input of a positive number in an asset account to increase it since the asset account has a debit normal balance. However, a liability account has a negative normal balance, so an increase in that account's value is a negative number. This leads to confusion and poor accounting practices. Following conventional mathematical principles, the positive and negative values should be able to be summed together. However, following accounting principles, the positive and negative values should not and cannot sum since they aren't the same underlying thing. A debit is something one has, while a credit is something one owes. Both values are treated as equivalent by the software by placing both values in the same column in a database. Since fundamentally the credit and debit are different things, the use of the software to treat them similar and in the same column is undesirable.

There are two known manners that current software applications treat transactions with debit and credit. First, debit is input as a normal value. If there is a value in a credit category, the user is required to reverse the sign and input the value as a negative number. This technique requires the user to adjust the input prior to input into the desired debit/credit categories.

Alternatively, some the software permits users to include the negative or positive values in the debit/credit categories and chooses to dismiss the negative or positive aspect of the number. Some known software dismisses the negative aspect of the number by multiplying it with a negative. Having accounting software function this way causes a loss of vector information (negative or positive) when using the values in later calculations, entries, and checks. In an effort to preserve the vector information, the accounting software is required to store the information elsewhere and manipulate the data at a later stage. The loss of the vector information leads to complex, fragile, and slower code, and data structures. In some instances, merging entities, such as companies that be merging, being acquired, or acquiring, are required to combine accounts. However, if the merging entities utilize different accounting systems this can cause serious confusion when they are merged. If one of the accounting programs multiplies amounts with negative in debit/credit categories, then the errors may be hard to discover.

In light of the methods disclosed in the known art, it is submitted that the present invention substantially diverges in design elements and methods from the known art and consequently it is clear that there is a need in the art for an accounting method and system that utilizes an Expanded Normal Equation. In this regard the instant invention substantially fulfills these needs.

### SUMMARY OF THE INVENTION

In view of the foregoing disadvantages inherent in the known types of accounting systems and methods now present in the known art, the present invention provides an accounting system and application that is implemented on an electronic device using an Expanded Normal Equation and a single-direction T-account (+,−) for all subsidiary accounts.

It is an object of the present invention to provide an accounting system and application, method of accounting associated excluding debit and credit designation comprising: receiving an account transaction, wherein the account transaction includes a real number amount; associating the account transaction with a first and second account, wherein each account corresponds to a variable of an expanded normal equation (ENE), wherein the ENE comprises a left-side equation and a right-side equation; assigning a first spatial position to the real number amount of the account transaction within a T-account, based on the first account category; assigning a second spatial position to the real number amount of the account transaction within the T-account, based on the second account category; wherein the spatial position comprises a left spatial position and a right spatial position, wherein the left spatial position is selected if the real number value is positive and the right spatial position is selected is the real number value is negative; wherein the left spatial position and the right spatial position correspond to the left-side equation and a right-side equation, respectively; inputting the real number value of the first spatial position or the real number value of the second spatial position into the ENE, respectively; calculating the ENE to balance the left-side equation with the right-side equation.

It is another objective of the present invention to provide double-entry accounting that separates the location of debits and credits (debits, left, credits, right) from the increases and decreases, focusing accountants on the effect on the account, rather than the location. The location (debits, left, credits, right) is automatically recorded in accordance to the expanded normal equation.

The historical accounting system of double-entry accounting was built based on manual systems of journals and ledgers, which required accounting clerks to record transactions without needing to understand the accounting equations or the relationship between accounts. The double-entry system provided some assurance that the accounts would remain in balance. For example, as accounts receivable clerk recorded customer balances in the ledger daily, while the accountant transferred a total of invoices to the journal. Using this manual system, it was more error-proof to work with debits and credits.

Students experience the most difficulties when deciding whether to debit or credit particular accounts. Debits and credits can cause either increases or decreases depending on the type of account, and this can be especially confusing for students. Asset accounts increase with debits and decrease with credits, while liability and equity accounts increase and decrease in the opposite fashion. Adding to this complexity is different treatment for revenue and expense accounts. This process is often counter-intuitive, especially for professionals who are attempting to understand financial statements and transactions, yet they are not the preparers of such statements.

It is another object of the present invention to implement a system of accounting excluding debit and credit designations on a computing platform. The computing platform comprises at least one processor and an electronic device adapted to receive an input from a user and communicate an output to the user via a communication interface, the communication interface communicatively coupled to the at least one processor. The non-transitory memory storing computer-readable instructions that, when executed by the at least one processor, cause the computing platform to: receive a data file by the at least one processor, via the communication interface, wherein the data file comprises information related to an account transaction, associate an account transaction with a first and second account category, wherein each account category corresponds to a variable of an expanded normal equation (ENE), wherein the ENE comprises a fixed left-side equation and a fixed right-side equation, wherein the first and second account category exclude debit and credit, wherein the fixed left-side equation comprises “Assets (A)+Expenses (E)+Contra-Liability (CL)+Contra-Equity (CEQ.)+Contra-Revenue (CR)”, wherein the fixed right-side equation comprises “Liabilities (L)+Owners' Equity (Eq.)+Revenues (R)+Contra-Asset (CA)+Contra-Expense (CE)”, determine if there is an issue associated with a data file by comparing a data file profile with the data file, wherein the data file profile comprises historical information associated with the data file, transmit via the communication interface, one or more commands directing to execute an automated response for the issue associated with the data file, wherein a smart node is adapted to generate a smart node value, the smart node value is generated by accept the input and generate a list of reconciling possibilities associated with the issue if an issue is found, wherein the smart node is adapted to automatically assign a first smart node value of the first account category to a first spatial position within a single direction T-account, automatically assign a second smart node value of the second account category to a second spatial position within the single direction T-account, wherein the first and second spatial positions of the single direction T-account comprises a left spatial position and a right spatial position, wherein the left spatial position is selected if the first smart node value is positive and the right spatial position is selected is the second smart node value is negative, wherein the left spatial position and the right spatial position of the single direction T-account correspond to the fixed left-side equation and the fixed right-side equation of the ENE, respectively.

The system of accounting excluding debit and credit designations on a computing platform utilizes a debit account and a credit account that are identifiably by an identification code. A table, such as a Chart of Accounts, stores all of the accounts and identify each as a credit or debit account. To get a balance on a specific account, the amount is positive if you are debiting a debit account, otherwise the amount is negated. In this way, the transactions are treated as general ledger entries that debit a first account and credit a second account. If the accounting needs to debit/credit more than two accounts, then more transactions are created.

It is yet another object of the present invention to create a system of accounting excluding debit and credit designations on a computing platform that removes some software practices that treat accounting values as non-vector information. In many software practices, numerical values are treated as mere numbers that can be stored or called in later uses. However, this practice creates technical problems as the accounting information is needed for creating financial statements and checking that entries are being treated appropriately. By utilizing the present system of accounting on a computing platform, the code is simpler (less torturous SQL), more intuitive, and better aligned with the described desirable accounting practices.

It is also another object of the present invention to provide a practical application of the accounting system implemented on a computer platform. In one example, the present invention, as recited in Claim 1, describes use of a data file and data profile to determine potential issues with the value received by the system. A smart node is used to generate a smart node value that preserves the vector information (negative or positive values) when using those value in later tables and financial statements. Accordingly, energy efficiency and the speed and capacity of the calculations are of great concern in accounting software's compared to other computer systems.

It is also another objective of the present invention to provide an improvement to computer technology through new features and better functionality. In one example, the present invention, as recited in Claim 1, the computer platform results in a less complex code that is better aligned with the described accounting practices. The use of a smart node to generate a smart node value and a list of reconciling possibilities associated with the issue if an issue is found is also a technical improvement. By identifying potential issues between data files and data file profiles, the presently claimed invention presents critical information to the user and provides solutions that align with the desirable accounting techniques.

It is therefore an objective of the following approach to use the expanded equation aforementioned, but only in its normal form by keeping accounts in their normal balances in the corresponding side of the equation. For example, Assets would be listed on the left side of the equation and Liabilities and Equity would be listed on the right side, thus the original accounting equation for permanent accounts.

It is therefore an objective of the present invention to contain both permanent and temporary accounts at all times. In this application and method, all accounts need to be presented in accordance to their normal balances. This is needed in order to post transactions, which normally affect two sides or two accounts, keeping the equation in balance. For example, the normal balance for assets and expenses is usually on the left, and therefore, they should be on the left side of the equation. Liabilities, equity and revenues have normal balances on the right and therefore, they should be on the right side of the equation. This is critical in order to post balances to the correct side of the equation, independent of the balances in the subsidiary accounts. In posting, every transaction would still have two sides and need to keep the expanded equation in balance. This equation assumes “No distributions” since they will be handled later as a contra-equity account.

This equation (Assets+Expenses=Liabilities+Owners' Equity+Revenues) is a rewrite of the prior one, moving expenses to the left and keeping revenues on the right. All transactions have to have corresponding increases and decreases, while keeping the ENE in balance. Further explanation of why this is beneficial to the learner of accounting, is the mere easiness of explaining increases and decreases to an account. For example, a company receiving cash has to increase the account, and a company selling inventory has to decrease the account. One can question if the increases and decreases would work for every transaction, and the answer is yes. There are logical explanations using increases and decreases to every single account after posting transactions. It is important to note that the mathematical difference between the traditional method and this invention is that in the traditional method the balancing, as well as the relative position of the account, is defined at the account level, while in this invention, the relative position of each account is fixed in the ENE. Several examples of transactions along with explanations are provided below.

Contra-accounts also have to be added to the ENE according to their normal balances as follows. Contra-accounts would also use a Single Direction T-account. This would allow for the recording of all transactions using the left and right side of the equation. All accounts either fall under the five categories of accounts or under contra-accounts these categories. The benefit of defining the contra accounts in the equation is the ability to encompass all types of accounts and their relationship to the main categories, also keeping the Normal Expanded Equation in balance. Understanding the relationship between accounts and contra-accounts clarifies the monthly financial dynamics between all the accounts for entity, further facilitating the ease of posting to them. Every contra-account should be presented in the opposite side of the equation of the original category. For example, assets are normally presented on the left side of the equation, therefore contra-assets which is an offset to the original account, should be presented on the right side. Again, contra-accounts should be presented in their normal position in the equation. The basic expanded equation with contra accounts is as follows: Assets (A)+Expenses (E)+Contra-Liability (CL)+Contra-Equity (CEQ.)+Contra-Revenue (CR)=Liabilities (L)+Owners' Equity (Eq.)+Revenues (R)+Contra-Asset (CA)+Contra-Expense (CE).

In this approach, distributions to stockholders, or dividends, is a contra-account to equity which explains its normal location on the left side of the equation. Another example is accumulated depreciation which is a contra-asset. This account should be placed on the right side of the equation, since it carries an offset balance to an asset account. This expanded equation can handle any type of account including accruals (liabilities), cost of goods sold (expenses), or treasury stock (contra-equity), sales discounts (contra-revenues), bond discount (contra-liability). Keeping the equation in its normal format allows for the easy use of recording transactions by keeping the equation in balance. To proof the equation even further, one can take any published Trial Balance and plug it in the equation.

It is another objective of the present invention to use the Expanded Normal Equation to support the use of a single-direction T-account (+,−) for all subsidiary accounts. After every transaction, posting occurs in the subsidiary account and in the equation. The posting will occur via software.

It is yet another objective of the present invention to increase the ease of understanding the increases and decreases without the directional confusion of “debits” and “credits.”

It is therefore an object of the present invention to provide a new and improved accounting method and application that has all of the advantages of the known art and none of the disadvantages.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

FIG. 1 shows a perspective view of an embodiment of the system and method of accounting excluding debit and credit designation.

FIG. 2 shows a flowchart of the sequence of steps from a traditional equation to an expanded normal equation of an embodiment of the system and method of accounting excluding debit and credit designation.

FIG. 3 shows a flowchart of a method of assigning accounts to variables of the expanded normal equation of an embodiment of the system and method of accounting excluding debit and credit designation.

FIG. 4 shows a screen view of a table of accounts entered into a program of an electronic device executing an embodiment of the method of accounting excluding debit and credit designation.

FIG. 5 shows a flowchart of an embodiment of the assigning accounts of an embodiment of the system and method of accounting excluding debit and credit designation.

FIG. 6 shows a screen view of a table of transaction details of an embodiment of the system and method of accounting excluding debit and credit designation.

FIG. 7 shows a flowchart of a transaction details report of an embodiment of the system and method of accounting excluding debit and credit designation.

FIG. 8a shows a screen view of a transaction details report table of an embodiment of the system and method of accounting excluding debit and credit designation.

FIG. 8b shows another screen view of a transaction details report table, continuing from FIG. 8a., of an embodiment of the system and method of accounting excluding debit and credit designation.

FIG. 8c shows another screen view of a transaction details report table, continuing from FIG. 8b., of an embodiment of the system and method of accounting excluding debit and credit designation.

FIG. 9 shows a screen view of a transaction report table of an embodiment of the system and method of accounting excluding debit and credit designation.

FIG. 10a shows a screen view of a trial balance report of an embodiment of the system and method of accounting excluding debit and credit designation.

FIG. 10b shows another screen view of a trial balance report, continuing from FIG. 10a, of an embodiment of the system and method of accounting excluding debit and credit designation.

FIG. 11 shows a screen view of journal entries generated using the expanded normal equation of an embodiment of the system and method of accounting excluding debit and credit designation.

FIG. 12 shows a screen view of multiple single-direction T-accounts using the expanded normal equation of an embodiment of the system and method of accounting excluding debit and credit designation.

FIG. 13a shows a screen view of a single direction T-account displaying a liability and asset transaction of an embodiment of the system and method of accounting excluding debit and credit designation.

FIG. 13b shows a screen view of a single direction T-account displaying an asset and expense transaction of an embodiment of the system and method of accounting excluding debit and credit designation.

FIG. 13c shows a screen view of a single direction T-account displaying an asset and revenue transaction of an embodiment of the system and method of accounting excluding debit and credit designation.

FIG. 13d shows a screen view of a single direction T-account displaying an asset and equity transaction of an embodiment of the system and method of accounting excluding debit and credit designation.

FIG. 13e shows a screen view of a single direction T-account displaying an asset and liability transaction of an embodiment of the system and method of accounting excluding debit and credit designation.

FIG. 13f shows a screen view of a single direction T-account displaying an expense and liability transaction of an embodiment of the system and method of accounting excluding debit and credit designation.

FIG. 13g shows a screen view of a single direction T-account displaying an asset and revenue transaction of an embodiment of the system and method of accounting excluding debit and credit designation.

FIG. 13h shows a screen view of a single direction T-account displaying an asset and contra-equity transaction of an embodiment of the system and method of accounting excluding debit and credit designation.

FIG. 13i shows a screen view of a single direction T-account displaying a multiple asset transaction of an embodiment of the system and method of accounting excluding debit and credit designation.

FIG. 13j shows a screen view of a single direction T-account displaying an expense and contra-asset transaction of an embodiment of the system and method of accounting excluding debit and credit designation.

FIG. 14 shows a screen view of an unadjusted trial balance generated using the transactions in FIGS. 13a-13j of an embodiment of the system and method of accounting excluding debit and credit designation.

FIG. 15 shows a screen view of month-end closing report generated using journal entries of an embodiment of the system and method of accounting excluding debit and credit designation.

FIG. 16 shows a screen view of a post-closing trial balance for month-end closing of FIG. 15.

### DETAILED DESCRIPTION OF THE INVENTION

Reference is made herein to the attached drawings. For the purposes of presenting a brief and clear description of the present invention, the preferred embodiment will be discussed as used for accounting practices and applications using an Expanded Normal Equation (ENE). In the description that follows, the following are some brief definitions: Assets: tangible and intangible items that the company owns that have value (e.g. cash, computer systems, patents). In simplistic terms, things that one owns. Liabilities: money that the company owes to others (e.g. mortgages, vehicle loans). In simplistic terms, things that one owes. Owners' Equity (Equity): that portion of the total assets that the owners or stockholders of the company fully own; have paid for outright. In simplistic terms, things that one invested in and paid for fully. Revenue or Income: money the company earns from its sales of products or services, and interest and dividends earned from marketable securities. In simplistic terms, one's income. Expenses: money the company spends to produce the goods or services that it sells (e.g. office supplies, utilities, advertising). In simplistic terms, one's expenses. The figures are intended for representative purposes only and should not be considered to be limiting in any respect.

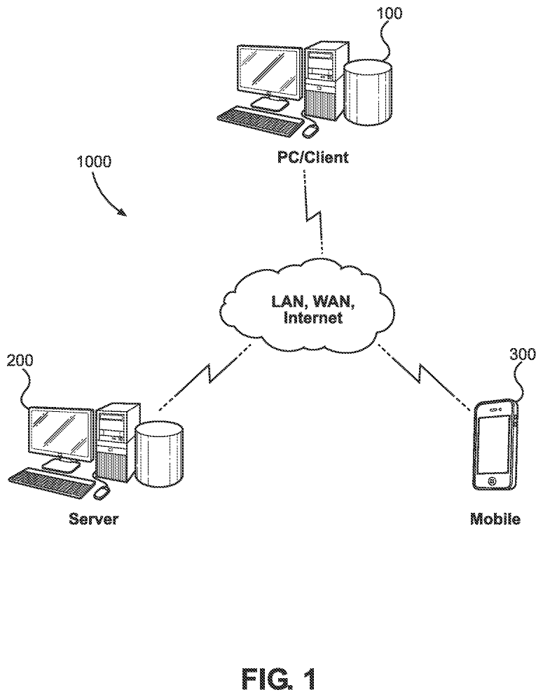

Referring to FIG. 1, there is shown a perspective view of an embodiment of the system and method of accounting excluding debit and credit designation. The system 1000 provides an application for supporting financial accounting systems and reporting. An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. Moreover, the present invention provides for a system and method for allowing a user to teach financial accounting using the ENE approach and for accountants to generate accurate journal entries and financial reports without the challenge of using debits and credits.

In the shown embodiment, the system 1000 includes a personal computer 100 that selectively accesses non-transitory memory of a server 200. The server 200 may host the application and provide access to the personal computer 100 and/or a portable electronic device 300, such as a smartphone. By hosting on the server, multiple users may access the same application and enter and/or retrieve information as needed. In one embodiment, the system is stored on non-transitory memory of a personal computer. In this way, the application and memory are local to the device and do not require wire or wireless connection to another device, such as the server 200.

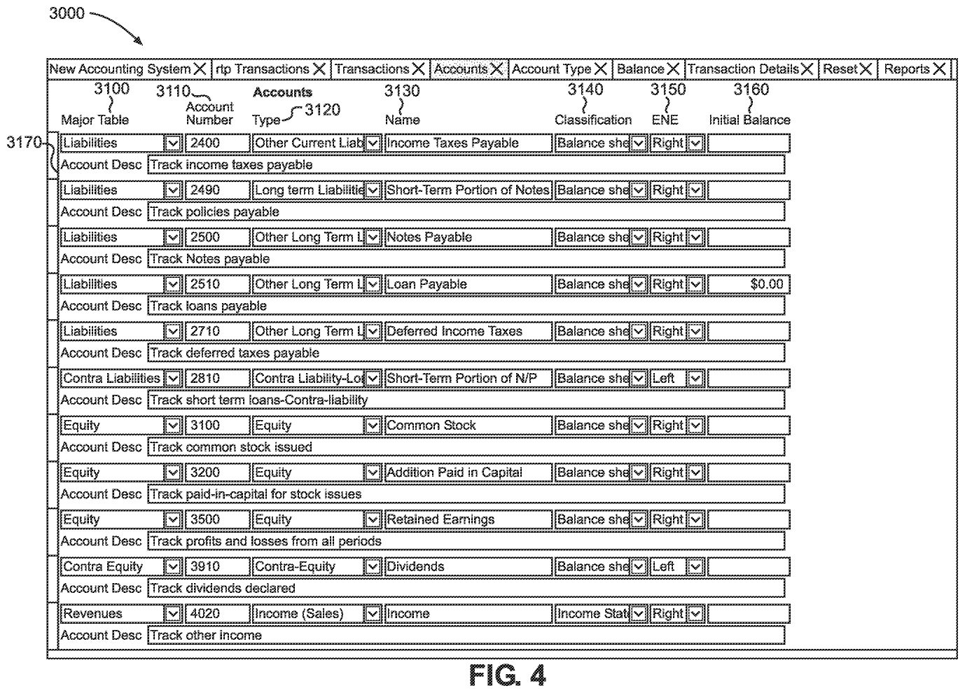

In some embodiments, the system of the present invention provides for the application to displayed on a graphical user interface (GUI) of the personal computer 100 and/or the portable electronic device 300e. The GUI provides an input that receives transaction information received from a user (as shown in FIG. 4).

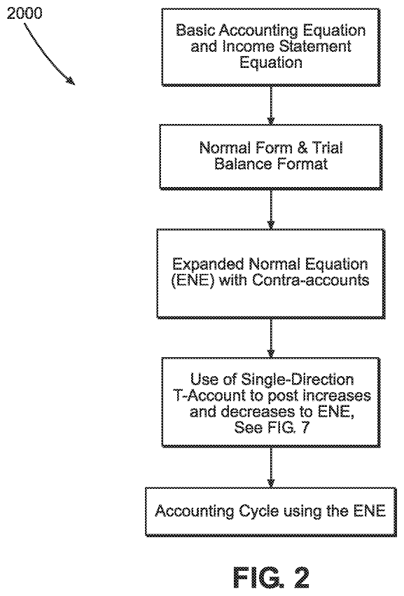

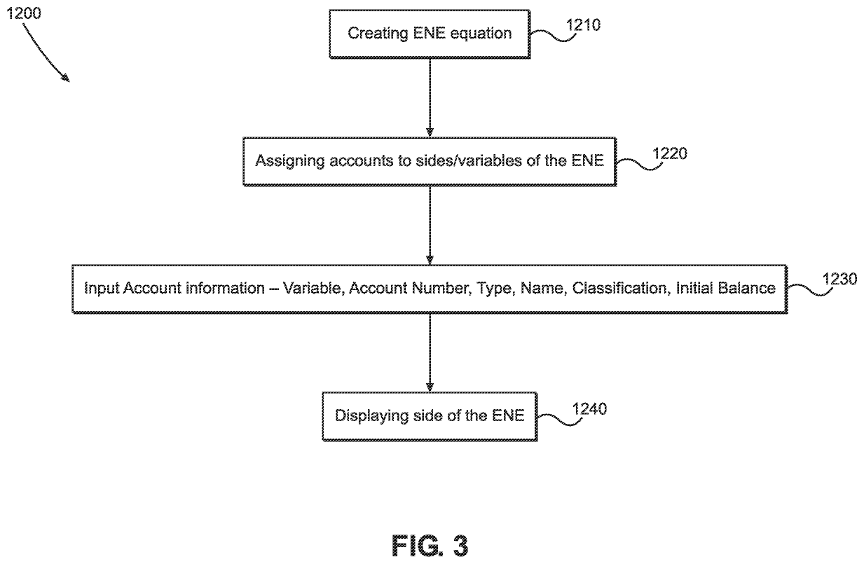

Referring now to FIGS. 2 and 3, there is shown a flowchart of the sequence of steps from a traditional equation to an expanded normal equation used by an embodiment of the system and a flowchart of a method of assigning accounts of an embodiment of the system of the present invention, respectively. The ENE is “Assets+Expenses=Liabilities+Owners' Equity+Revenues.” The system and method of accounting excluding debit and credit designation two non-dynamic equations (the Basic Accounting Equation and the Income Statement Equation) into the ENE in order to reflect the dynamic relationship between all Accounts 2100. Another way of expressing this in a business is that the permanent and temporary accounts are linked dynamically and there is no need to separate the equation, except for reporting and the creation of financial statements.

In the illustrated embodiment, the system 1000 generates Accounts assignments based on this dynamic mathematical relationship, wherein the mathematical relationship is derived from the ENE. The Accounts are assigned to either a right side of the ENE or to a left side of the ENE. Between the left and the right side of the ENE is an equal sign. For example, FIG. 2 provides a sequence of steps from a traditional equation to the ENE used by an embodiment of the system in order to assign Accounts to either a right side or left side of the equal sign. Conventionally, accounts on a left side of the traditional accounting equation are increased with a debit and accounts on the right are increased with a credit. However, in the illustrated embodiment, the ENE is organized with the Asset Account and Expense Account on the left and Liabilities Account, Owner's Equity Account and Revenues Account on the right.

Similarly, the system assigns contra-accounts opposite location of the original Account. For example, Contra-Asset such as the accumulated depreciation account is placed on the right side of the ENE while Assets are on the left. Contra-accounts are opposite to the original Account and mathematically have to be placed as such in the ENE. The mathematical end-result of the contra-account is deducted from the original Account, thus the opposite placement in the ENE.

In some embodiments, once the Accounts are assigned to either the left side or right side of the ENE, the system is configured to generate a single direction T-Account for each transaction received by the system. Each T-Account displays increases on a left side thereof and a decrease on a right side thereof. T-accounts are (+, −) for assets, liabilities, equity, revenue, expenses, and all contra-accounts. In the illustrated embodiment, after all transactions are received by the system, the balance of the T-Accounts generated are posted to the left or right side of the ENE. All T-Accounts are single direction (+,−) account. In some embodiments, the system receives the transaction information in each relevant T-Account and then posts the transaction information in the corresponding fixed location of the ENE. In every transaction, the ENE is kept in balance.

The expanded equation of accounting as follows: “Assets=Liabilities+((Owners' Equity+(Revenues−Expenses)−Distributions to Stockholders)).” As persons and companies continue their business activities, their assets and liabilities continue to change. This is reflected in the monthly activity of additional revenues and expenses. The net of this monthly activity posts into the permanent accounts: Assets, Lability, and Equity. Mathematically, this expression can be simplified to the following (assuming no distributions, since they will be handled later as a contra-equity category), taking the parentheticals out. Note, the following assumes no contra accounts such as dividends: “Assets=Liabilities+Owners' Equity+Revenues−Expenses.”

This equation (Assets+Expenses=Liabilities+Owners' Equity+Revenues) is derived from the above equations and is the ENE. All transactions require a corresponding increases and decreases, while keeping the ENE in balance. Further explanation of why this is beneficial to the learner of accounting, is the mere easiness of explaining increases and decreases to an account as opposed to the concept of credit and debit.

Referring now to FIG. 4, there is shown a screen view of a table of accounts being entered into a program of an electronic device executing the present invention. In the illustrated embodiment, the system 1000 comprises the application 3000 and provides for the manual or automatic assigning of accounts to variables of the ENE 1230 (as shown in FIG. 3). The variables of the ENE remain on the relative right side and left side of the equals sign. In the shown embodiment, the application 3000 provides for account information to be entered 2300. The account information includes, but is not limited to Variable 3100, Account Number 3110, Type 3120, Name 3130, Classification 3140, Initial Balance 3160, and Account Description 3170. Once the account information has been entered, the ENE position 3150 is generated and displayed 2400 by the application 3000.

In the shown embodiment of FIG. 4, a plurality of accounts may be stored on the system 1000. Moreover, the accounts may be selectively entered, simultaneously or at different times. The ENE can handle any type of account including accruals (liabilities), cost of goods sold (expenses), or treasury stock (contra-equity), sales discounts (contra-revenues), bond discount (contra-liability).

Contra-accounts assigned by the system to the application are also configured to be represented in a single Direction T-account when executed by the system. This would allow for the recording of all transactions using the left and right side of the equation. The benefit of defining the contra accounts in the equation is the ability to encompass all types of accounts and their relationship to the main categories, also keeping the Normal Expanded Equation in balance. Understanding the relationship between accounts and contra-accounts clarifies the monthly financial dynamics between all the accounts for entity, further facilitating the ease of posting to them. Every contra-account should be presented in the opposite side of the equation of the original category. For example, assets are normally presented on the left side of the equation, therefore contra-assets which is an offset to the original account, should be presented on the right side. Again, contra-accounts should be presented in their normal position in the equation. The basic expanded equation with contra accounts is as follows: Assets (A)+Expenses (E)+Contra-Liability (CL)+Contra-Equity (CEQ.)+Contra-Revenue (CR)=Liabilities (L)+Owners' Equity (Eq.)+Revenues (R)+Contra-Asset (CA)+Contra-Expense (CE).

In this approach, distributions to stockholders, or dividends, is a contra-account to equity which explains its normal location on the left side of the equation. Another example is accumulated depreciation which is a contra-asset. This account should be placed on the right side of the equation, since it carries an offset balance to an asset account. This expanded equation can handle any type of account including accruals (liabilities), cost of goods sold (expenses), or treasury stock (contra-equity), sales discounts (contra-revenues), bond discount (contra-liability). Keeping the equation in its normal format allows for the easy use of recording transactions by keeping the equation in balance. To proof the equation even further, one can take any published Trial Balance and plug it in the equation.

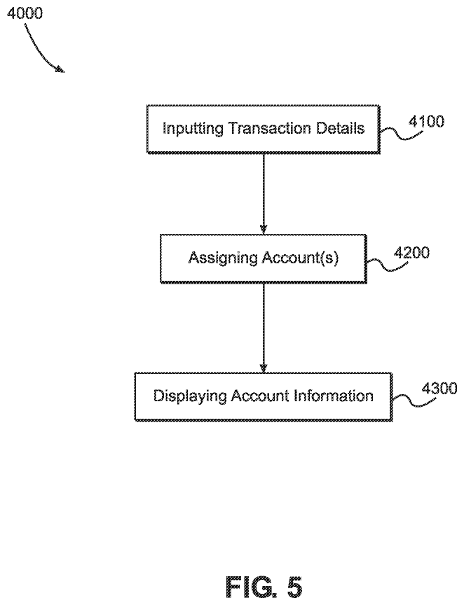

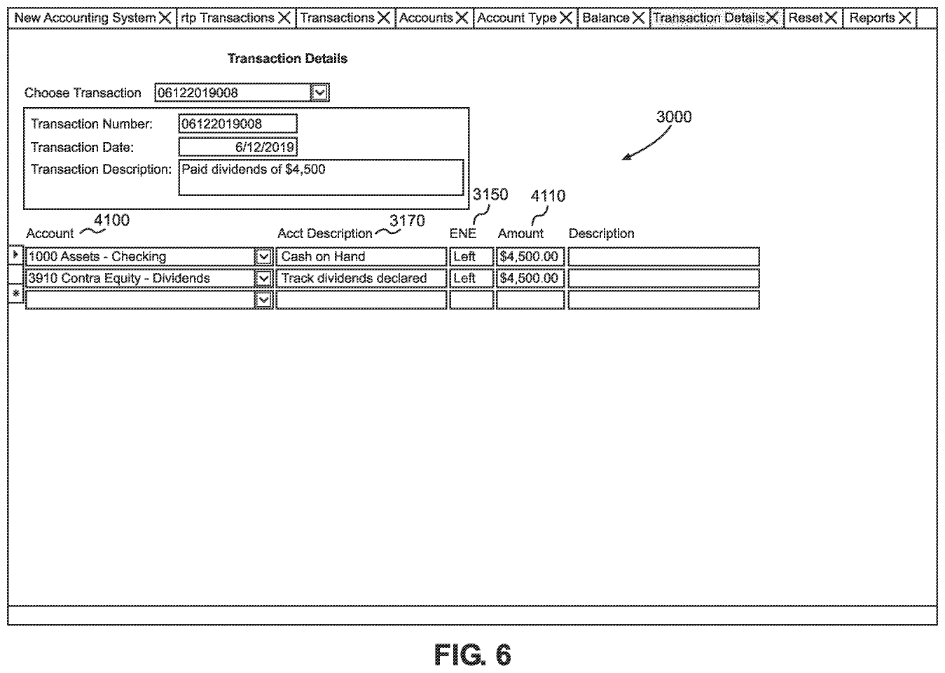

Referring to FIGS. 5 and 6, there is shown a flowchart assigning accounts of an embodiment of the system and method of accounting excluding debit and credit designation and a screen view of a table of transaction details of an embodiment of the system and method of accounting excluding debit and credit designation, respectively. In the shown embodiment of the method account details, each transaction is assigned to an account so as to be included in the ENE. The method comprises inputting transaction details 4100, either automatically or manually, assigning the transaction to an account 4200, and displaying account information 4300. The application 3000 provides for each transaction or journal entry to be entered. As shown in FIG. 6, the transaction details include, but are not limited to: account 4100 and amount 4120. The Account description 3170 and ENE 3150 are associated with the Account 4100 and imported by the application 3000.

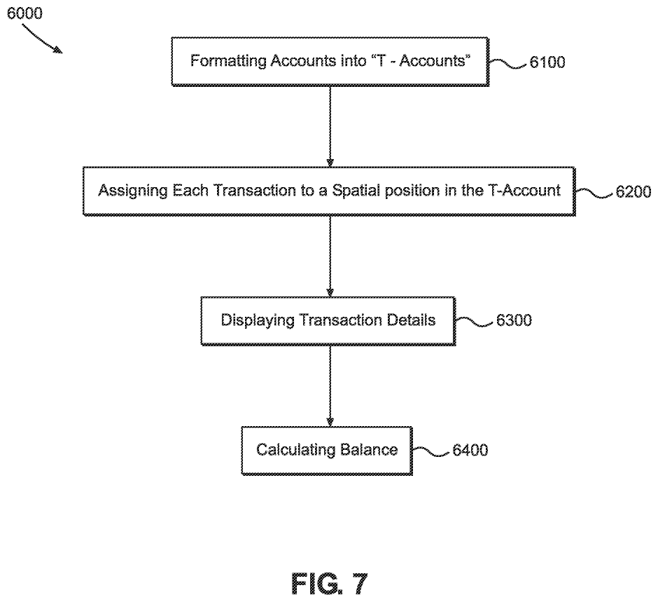

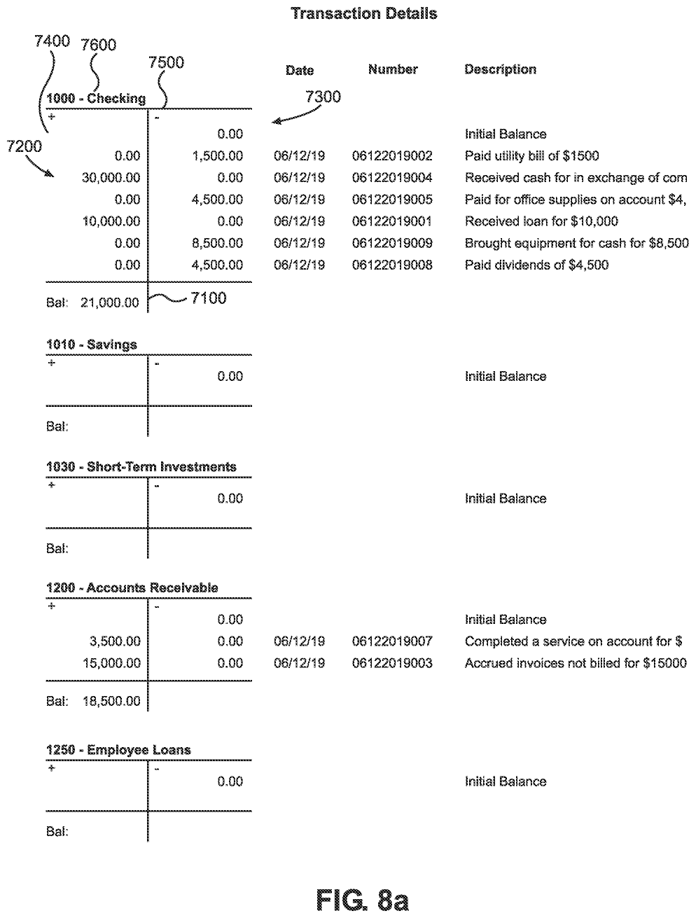

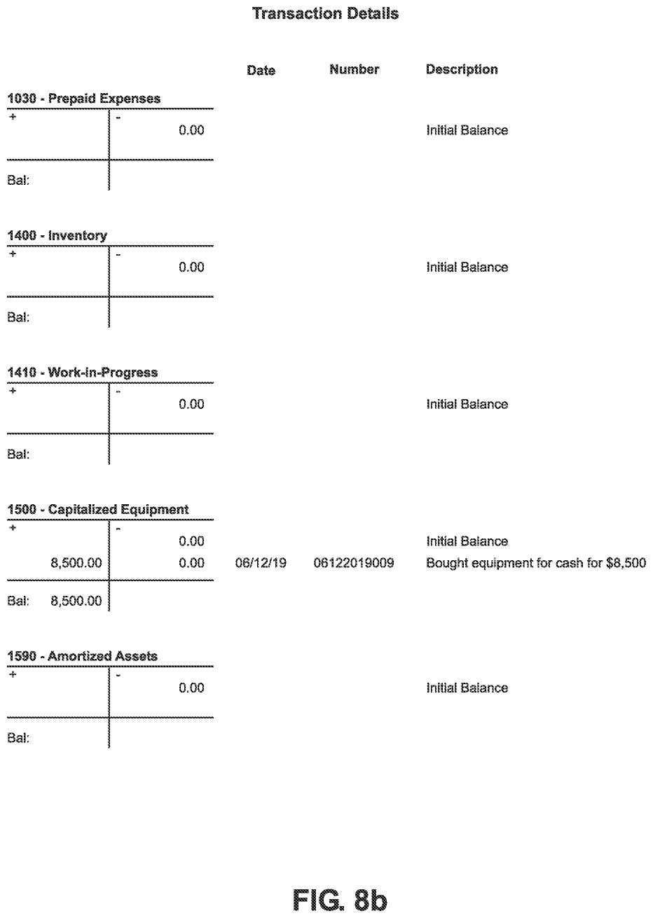

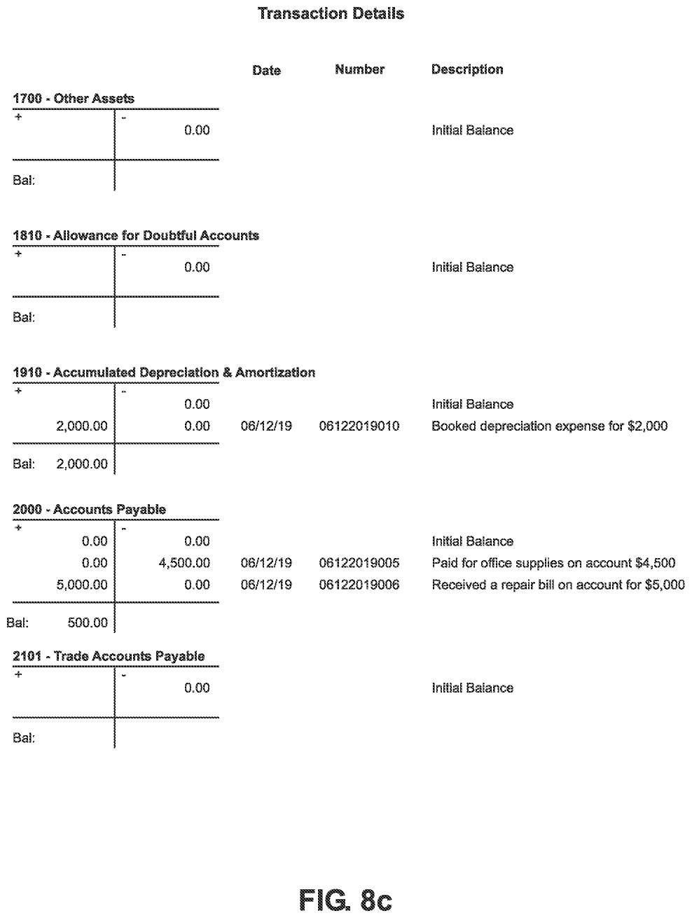

Referring to FIGS. 7-9, there is shown a flowchart of a transaction details report, screen views of a transaction details report table, and a screen view of a transaction report table of an embodiment of the system and method of accounting excluding debit and credit designation, respectively. In one embodiment, the application 3000 provides a plurality of reports. These reports include, but are not limited to: balance sheet, income statements, capital statements, cash flow, and the like. In one embodiment as shown in FIG. 7, the method of creating the Transaction report of FIGS. 8a-8c includes: formatting accounts into T-accounts 6100, assigning each transaction to a spatial position in the T-account 6200, displaying the transaction details 6300, and calculating the balance of each account 6400.

As seen in FIGS. 8a-8c, there is shown each account in a single T-account format or single-direction T-account. In the shown single T-account format, the T-account comprises a vertical dividing element 7100 and a horizontal dividing element at an upper end thereof, usually forming a “T” shape. In some embodiment, the horizontal dividing element is not present. The vertical element 7110 forms a left side 7200 and right side 7300. Each side 7200, 7300 includes a positive sign 7400 or a negative sign 7500 (+, −). In the shown embodiment, the left side 7200 includes the positive sign 7400 and the right side 7300 includes the negative sign 7500. In alternative embodiments, the signs 7400, 7500 may be positioned on the opposite right/left side.

All accounts 7600 increase and decrease using a single type of T-account (+, −). The balance of T-accounts are recorded in the ENE either in the left or right, according to the category and location in the Expanded Normal Equation: Assets+Expenses=Liabilities+Owners' Equity+Revenues. Using a single-direction T-account simplifies the mechanics of posting transactions and improves understandability. Further, this method allows for a visual representation of how the ENE remains in balance. It also allows for journal entries to be presented by increases and decrease rather than debits and credits.

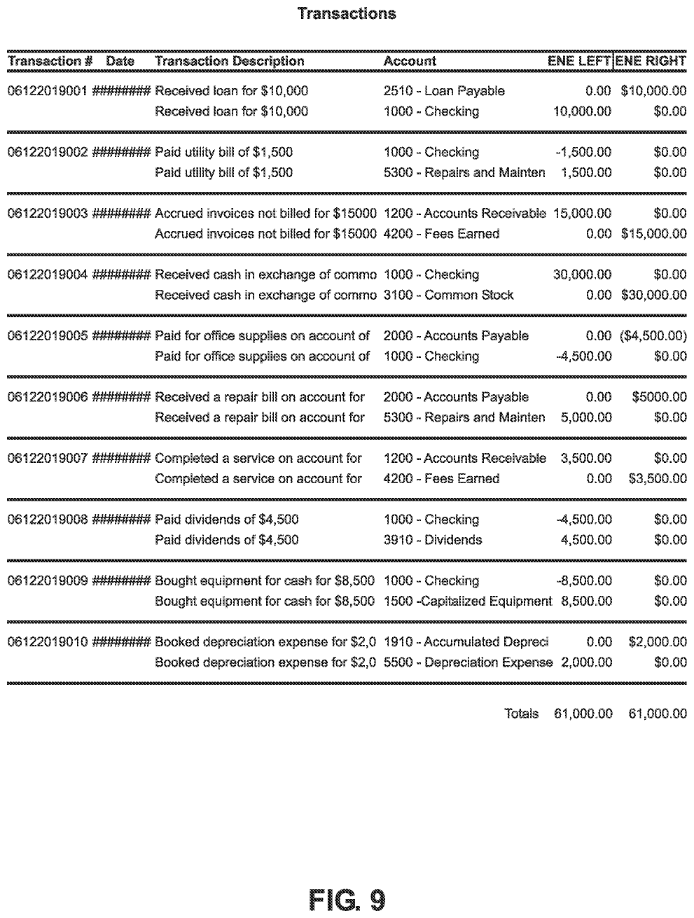

In the shown embodiment of FIG. 9, a portion of the transactions are shown in the transaction report. The plurality of transactions is provided with the associated transaction description and account information. These transactions correspond to the table of transaction details in FIG. 6.

Conventionally, in double-entry bookkeeping all financial transactions are considered to affect at least two of a company's accounts. One account will get a debit entry, while the second will get a credit entry to record each transaction that occurs. This debit and credit entry may be formatted into a different T-account format, wherein the debits are positioned on one side of the dividing element and credits are positioned on the opposing side. The rules of debits and credits in accounting are based on reflecting the increases and decreases in the account along with the location of the account in the accounting equation. For example, an increase in a liability is different than an increase in an asset, due to the reflection of account location in the accounting equation. This combination makes accounting using debits and credits more complex than it needs to be, since the recorder has to think of the increase or decrease along with the location in the equation (left, right).

The present invention serves to separate the subsidiary account location (left, right) from the underlying increase or decrease caused by the transaction. The present invention focuses on the increase and decrease as a first step and then records the location in the equation as a second step. The benefit of the present invention stems from the accountant's ability to focus on the logical increases and decreases without the confusion over the location of the account in the accounting equation. This also simplifies all accounting education as well as the teaching of accounting courses. This system and method provide for specific application to instructional aids, accounting software including applications, as well as improved database capabilities to serve accounting needs.

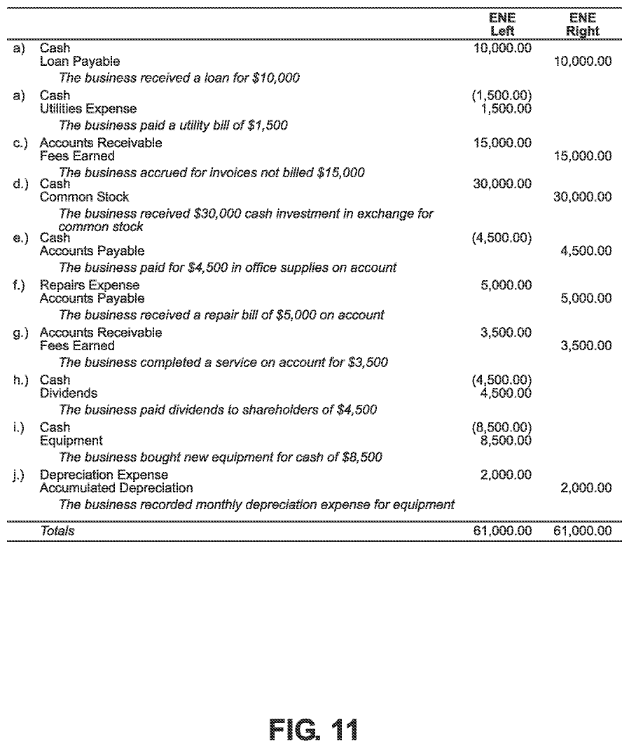

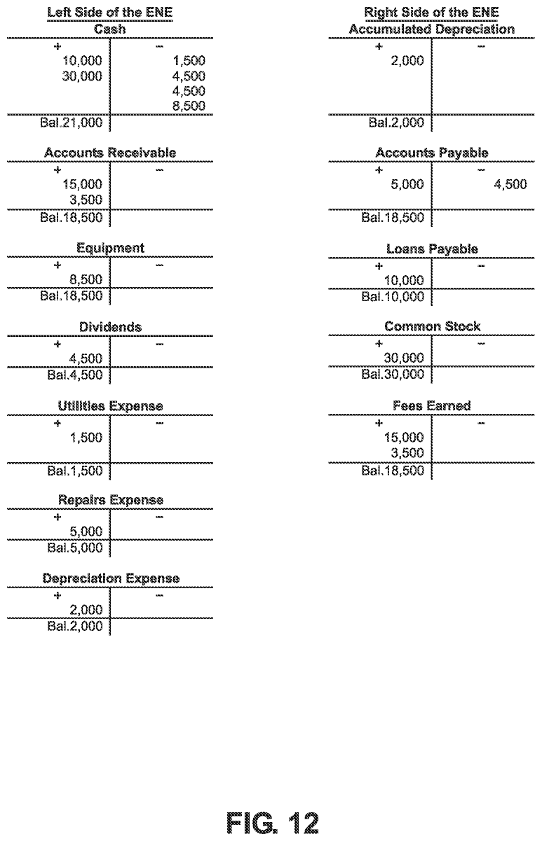

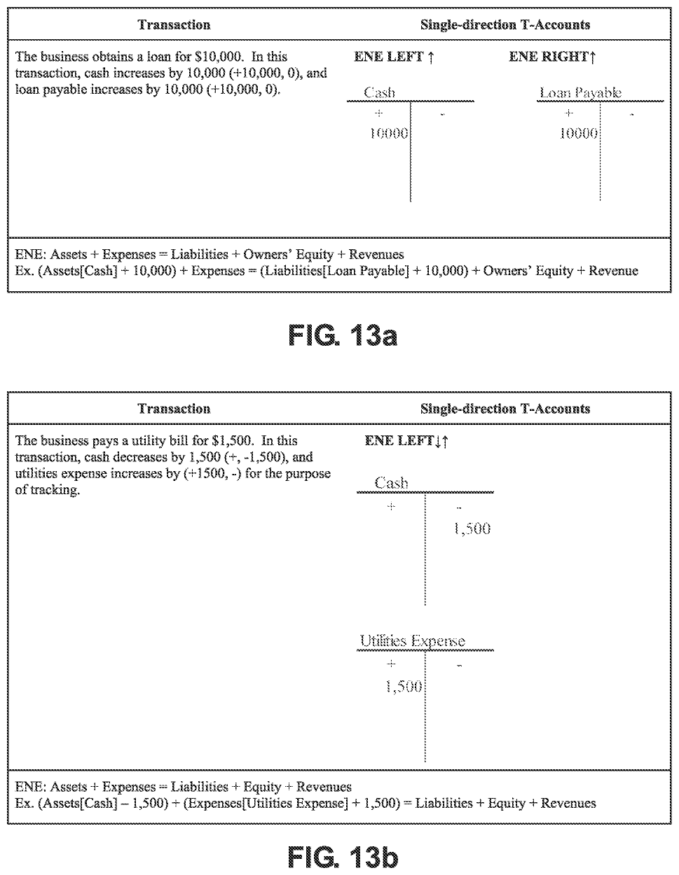

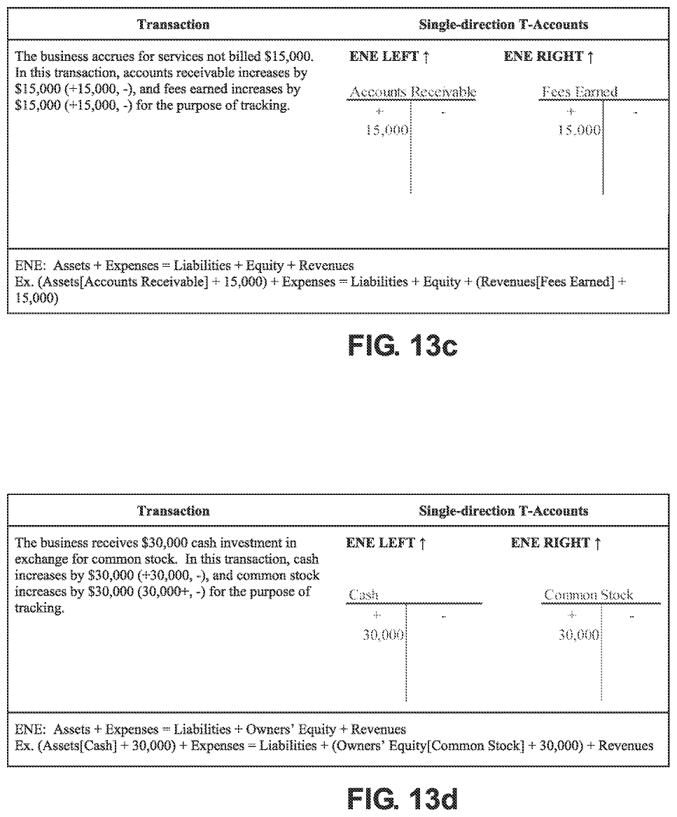

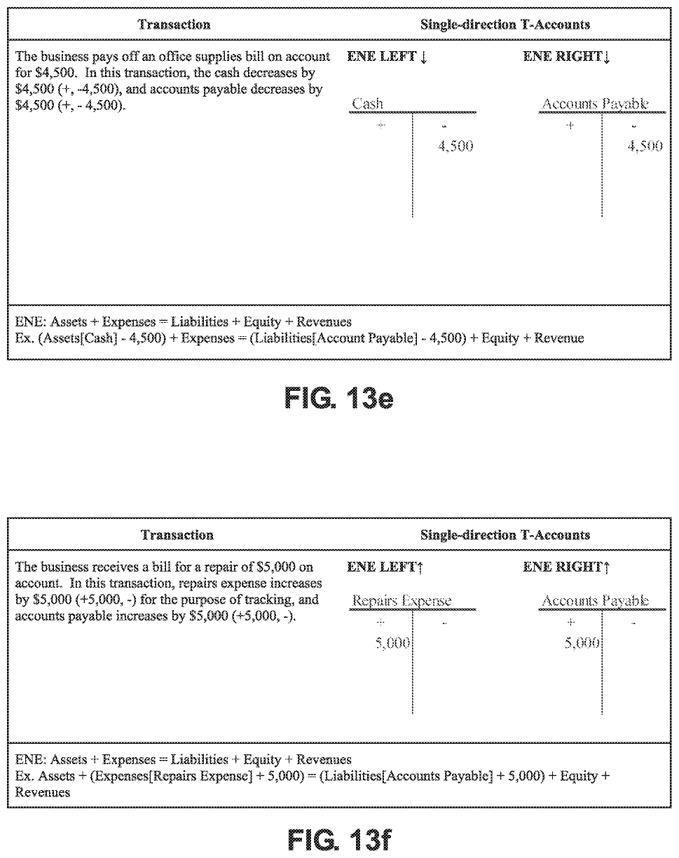

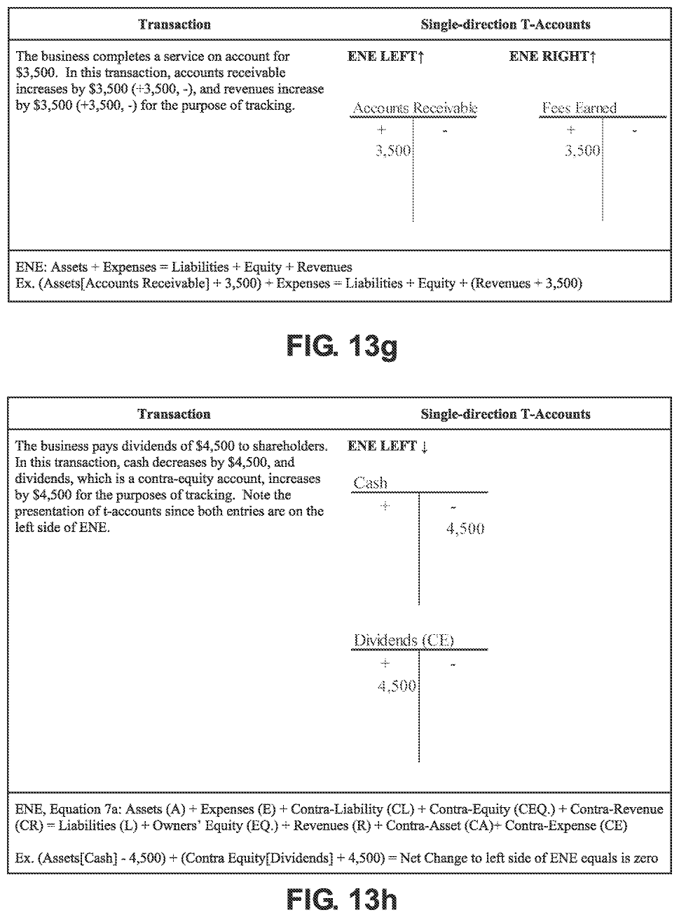

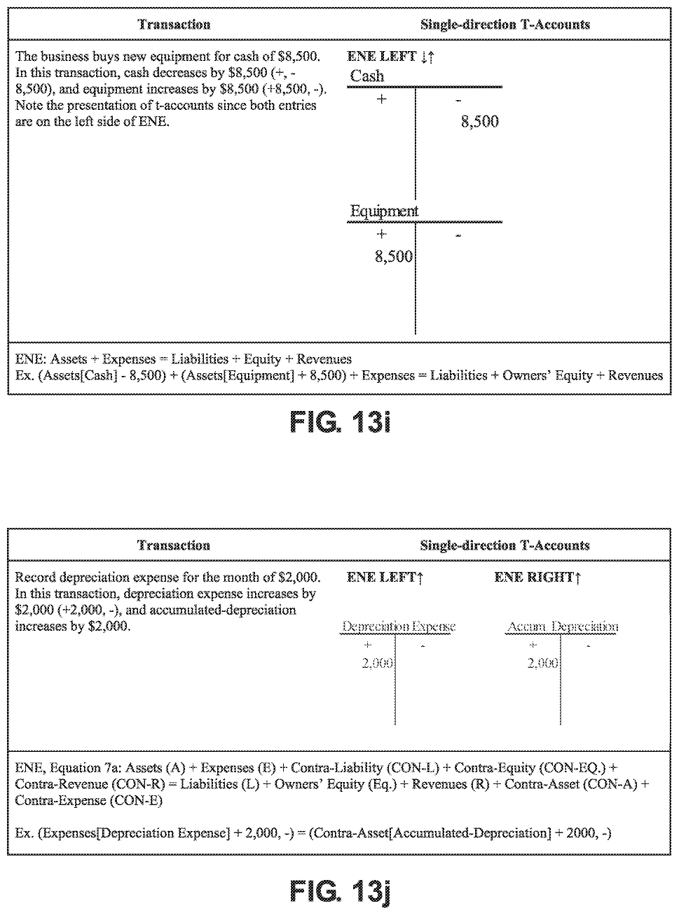

Referring to FIGS. 11 and 12, there is shown a screen view of journal entries generated using the expanded normal equation and a screen view of multiple single-direction T-accounts generated using the expanded normal equation of an embodiment of the system and method of accounting excluding debit and credit designation, respectively. In a first example using a method of the present invention, a business obtains a loan for $10,000. Cash would increase by 10,000 (+10,000, 0) and Loan Payable would increase by 10,000 (+10,000, 0). This is represented in the equation “(Assets/Cash, +10,000)+Expenses=(Liabilities/Loan Payable, +10,000)+Owners' Equity+Revenues” and can be seen in FIG. 13a.

In a second example using a method of the present invention, a business pays a utility bill for $1,500. Cash would decrease by 1,500 (+, −1,500) and Utilities Expense would increase by (+1500, −). This is represented in the equation “(Assets/Cash, −1500)+(Expenses/Utilities Expense, +1500)=Liabilities+Equity+Revenues” and can be seen in FIG. 13b. The T-accounts are listed on top of each other indicating same side of ENE (Left).

In a third example using a method of the present invention, a business accrues for services not billed $15,000. Accounts Receivable would increase by $15,000 (+15,000, −) and Fees Earned would increase by $15,000 (+15,000, −). This is represented in the equation “(Assets/Accounts Receivable, +15,000)+Expenses=Liabilities+Equity+(Revenues/Fees Earned, +15,000)” and can be seen in FIG. 13c.

In a fourth example using a method of the present invention, a business receives $30,000 cash investment in exchange for common stock. Cash would increase by $30,000 (+30,000, −) and Common Stock would increase by $30,000 (30,000+, −). This is represented in the equation “(Assets/Cash, +30,000)+Expenses=Labilities+(Owners' Equity/Common Stock, +30,000)+Revenues” and can be seen in FIG. 13d.

In a fifth example using a method of the present invention, a business pays off an office supplies bill on account for $4,500. Cash would decrease by $4,500 (+, −4,500) and Accounts Payable would decrease by $4,500 (+, −4,500). This is represented in the equation “(Assets/Cash, −4,500)+Expenses=(Liabilities/Account Payable, −4,500)+Equity+Revenues” and can be seen in FIG. 13e.

In a sixth example using a method of the present invention, a business receives a bill for a repair of $5,000 on account. Repairs Expense would increase by $5,000 (+5,000, −) and Accounts Payable would increase by $5,000 (+5,000, −). This is represented in the equation “(Expenses/Repairs Expense, +5,000)=(Liabilities/Accounts Payable, +5,000)+Equity+Revenues” and can be seen in FIG. 13f.

In a seventh example using a method of the present invention, a business completes a service on account for $3,500. Accounts Receivable would increase by $3,500 (+3,500, −) and Revenues would increase by $3,500 (+3,500, −). This is represented in the equation “(Assets/Accounts Receivable, +3,500)+Expenses=Liabilities+Equity+(Revenues, +3,500)” and can be seen in FIG. 13g.

In an eighth example using a method of the present invention, a business pays dividends of $4,500 to shareholders. Cash would decrease by $4,500 and increase dividends which is a contra-equity account by $4,500. This is represented in the equation “(Assets/Cash, −4,500)+(Contra Equity/Dividends, +4,500)=Net Change to left side of ENE equals is zero” and can be seen in FIG. 13h. In FIG. 13h, the T-accounts are listed on top of each other indicating same side of ENE (left).

In a ninth example using a method of the present invention, a business buys new equipment for cash of $8,500. Cash would decrease by $8,500 (+, −8,500) and Equipment would increase by $8,500 (+8,500, −). This is represented in the equation “(Assets/Cash, −8,500)+(Assets/Equipment, +8,500)+Expenses=Liabilities+Owners' Equity+Revenues” and can be seen in FIG. 13i. In FIG. 13i, the T-accounts are listed on top of each other indicating same side of ENE (Left).

In a tenth example using a method of the present invention, a business records Depreciation Expense for a Month, wherein the expense is $2,000. Depreciation Expense would increase by $2,000 (+2,000, −) for tracking and Accumulated Depreciation would increase by $2,000 for continuous tracking. This is represented in the equation “Expenses/Depreciation Exp (+2,000, −)=Contra-Asset/Accumulated Depreciation (+2000, −)” and can be seen in FIG. 13j. In all the transactions shown in FIG. 13j, the increases and decreases in the T-accounts would be recorded in the same location, on the left and right side of the account. The second step would be to transfer the balance of the two transacting accounts into the ENE.

In most of the accounting texts, the authors start explaining transactions using increases and decreases, and then switch to debits and credits approach, focusing on the location in the account (left, right) rather than the (increase, decrease). This method separates the location (dr., left, cr., right) from the increases and decreases, focusing accountants on the effect on the account, rather than the location. The location (dr., left, cr., right) is automatically recorded in accordance to the expanded normal equation.

An alternate view of FIGS. 13a-13j is shown in FIG. 12, whereas FIG. 11 shows a list of journal entries from the transactions shown in FIG. 12. The journal entries shown in FIG. 11 demonstrate how the equation remains in balance with every transaction. All Accounts increase and decrease using a single type of T-account (+, −). Balance of T-accounts are recorded in the ENE either in the left or right, according to the category and location in the Expanded Normal Equation: Assets+Expenses=Liabilities+Owners' Equity+Revenues.

Referring to FIG. 11, there is shown a list of ENE journal entries using increases and decreases based on the system and method from FIG. 12. In the shown embodiment, increases to accounts have no notation, and decreases are noted as decreases “−”. Further, increases and decreases influencing one side of the equation are noted as such. See example of journal entry b, h, and i.

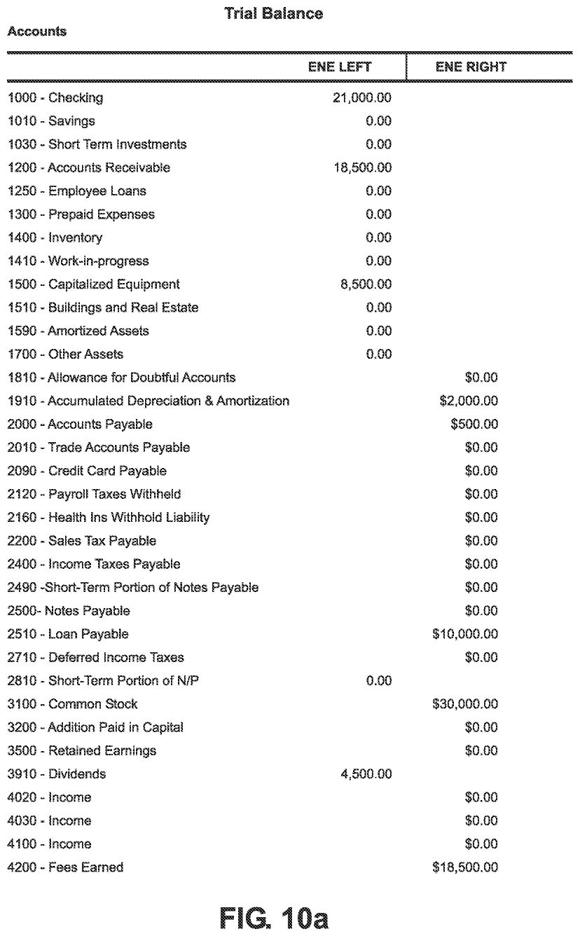

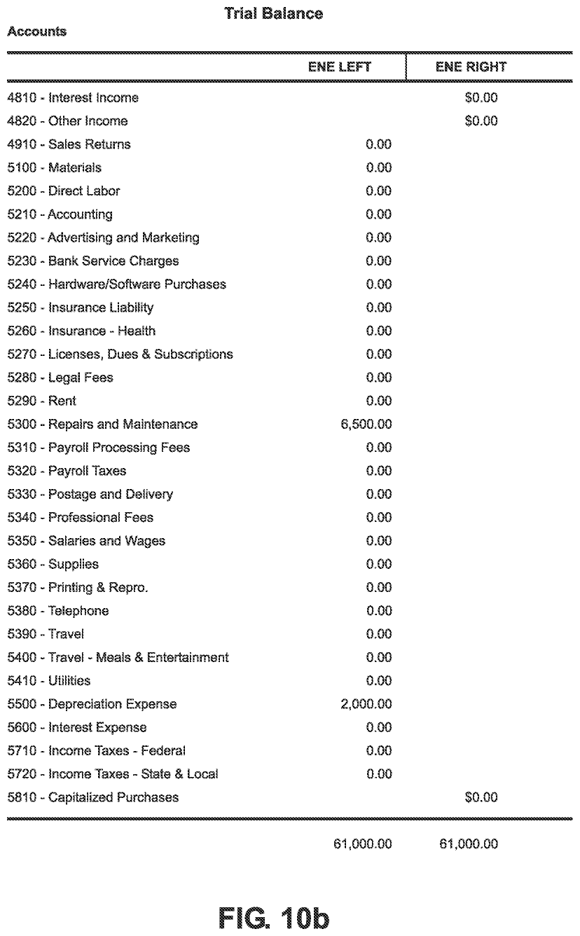

Referring to FIG. 12, there is shown a list of ENE Account Balances listed in accordance to their location in the Expanded Normal Equation from FIG. 11 and based on the system and method of accounting excluding debit and credit designation. In the shown embodiment, there is shown a list of account balances listed in accordance to their location in from the transactions from Tables 1-10 and again defined in FIG. 10A-10C.

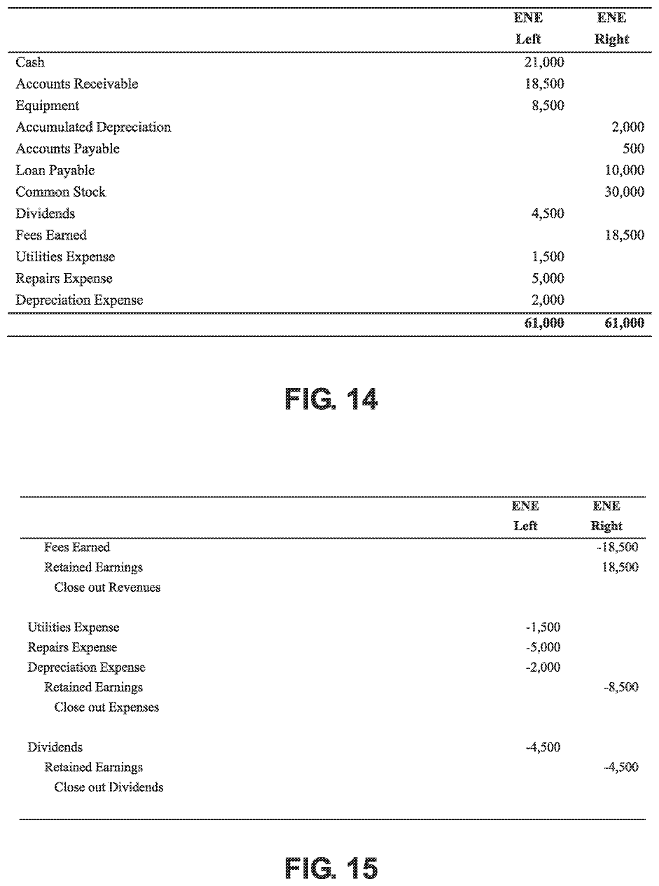

Referring to FIGS. 10a and 10b, there are shown screen views of a trial balance report of an embodiment of the system and method of accounting excluding debit and credit designation. Referring to FIG. 14, there is shown a screen view of an unadjusted trial balance generated using the transactions in FIGS. 13a-13j. In the illustrated embodiment, the titles for balances in the accounts are shown as “ENE Left” and “ENE Right” instead of “Debit” and “Credit”. Note with this approach of having the balances in the Trial Balance correspond to Left and Right side of the equation allows for a clearer explanation why an account is listed on the left or the right. If an account falls on the left side of the equation, then it would be listed on the left side of the trial balance and the same can be said for the right side. Also note that the ENE allows negative account balances to appear, if some arise. For example, if there is a negative balance in the accounts receivable account, then it would be stated as such in the Trial Balance. This would not impact the balancing of the equation, since mathematically positive and negative numbers can be added in the equation.

The month-end closing process can occur in the equation by offsetting the accounts on each side of the ENE to the owners' equity category and more specifically retained earnings. In addition, the dividends which as a contra-equity account can also be offset to retained earnings in owners' equity. Note the expenses and contra-equity accounts need offsets to move them to the other side of the equation, but the revenues category is merely collapsed into owners' equity or added to it.

Using the ENE below, the closing process is shown via equations: “Assets (A)+Expenses (E)+Contra-Liability (CL)+Contra-Equity (CEQ.)+Contra-Revenue (CR)=Liabilities (L)+Owners' Equity (EQ.)+Revenues (R)+Contra-Asset (CA)+Contra-Expense (CE)” or “8,000(A)+8,500 (E)+4,500 (CEQ)=10,500(L)+30,000 (EQ)+18,500 (R)+2,000 (CA)” or “48,000(A)+8,500 (E)−8,500 (Closing)+4,500 (CEQ)−4,500 (CEQ)=10,500(L)+((30,000 (EQ)+18,500 (R) Closing)−8,500 (E) Closing)−4,500 (CEQ) Closing)+2,000 (CA)” or “48,000(A)=10,500(L)+35,500(EQ.)+2,000 (CA).”

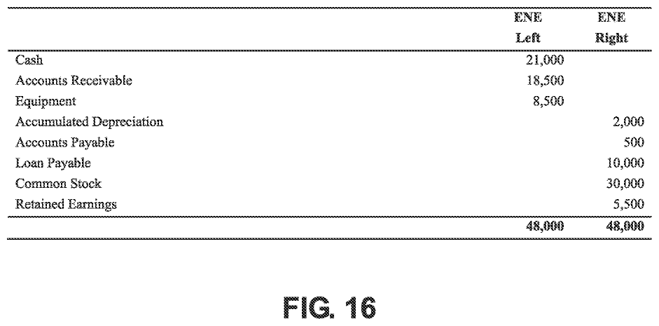

The closing process can also occur through journal entries shown in FIGS. 15 and 16.

It is noteworthy to mention that the ENE assumed that categories such as “other income” and “other expenses” would be created as subcategories of the main revenues and expense categories. The balancing of the ENE remains the same with including the subcategories. The location of these subcategories on the financial statement would be handled the same way as in the traditional method using later ranges in the chart of accounts.

The ENE builds on the current expanded equation to this form: “Assets=Liabilities+Owners' Equity+Revenues−Expenses” or “Assets+Expenses=Liabilities+Owners' Equity+Revenues”. Additionally, for already accountants, this is the same equation implied in the Trial Balance now with the assets and expenses on one side and liabilities, owners' equity and revenues on the other. Contra-accounts can be thought of as derivatives of the ENE, so knowing that assets are on the left of the ENE means that a contra-asset will be on the right side of the ENE, etc. The increase and decreases to the individual accounts are more intuitive to the recorder of the transactions that “debits” and “credits” thus the reason for most accounting texts starting with this approach.

In some embodiments, the system and method comprise a GUI that captures a user's input (automatically or manually) as a single T-Account approach (+,−). However, in another embodiment, the method comprises a GUI that captures a user's input as a sign T-Account approach (+,−) using single direction increases and decreases for all accounts. In other embodiments, additional computations to build financial statements are disposed in the software using the ENE and incorporated into the GUI.

In one embodiment, the account and transaction information are stored on the memory of the system. The information actively allows increases and decreases to accounts in each category (e.g., assets, liabilities, owners' equity). As the inputting/posting occurs, the application may display the accounting equation, reminding the user of keeping the equation balanced. Other computations to build financial statements can be built in the application using the ENE.

In one embodiment, this new accounting application eliminates the need for integration between other database and accounting software. In place of this integration, all the accounting functions can happen within the application. This independence facilitates reporting, as well as the creation of new statements.

The present invention eliminates requiring a user to enter debits and credits into the system by combining permanent and temporary accounts into the ENE. The benefit of combining the accounts into one equation is it focuses the user on the relationship between all accounts and allows multiple financial reports to be generated automatically using the ENE. Understanding the relationship between temporary and permanent accounts clarifies the monthly financial dynamics of an entity or an organization. This also simplifies all accounting textbooks as well as the teaching of accounting courses. The prior equation separates temporary and permanent accounts. Since temporary accounts are closed out to the permanent accounts every month. This method allows for the entire posting process to occur within a single dynamic equation. One single equation is easier to process than two separate ones in the software. All financial statements can be derived from this single equation. This also simplifies accounting education as well as the teaching of accounting courses.

In one embodiment, the system of accounting excluding debit and credit designations on a computing platform comprises at least one processor and an electronic device adapted to receive an input from a user and communicate an output to the user via a communication interface, the communication interface communicatively coupled to the at least one processor. Non-transitory memory store computer-readable instructions that, when executed by the at least one processor, cause the computing platform to: receive a data file by the at least one processor, via the communication interface, wherein the data file comprises information related to an account transaction, associate an account transaction with a first and second account category, wherein each account category corresponds to a variable of an expanded normal equation (ENE), wherein the ENE comprises a fixed left-side equation and a fixed right-side equation, wherein the first and second account category exclude debit and credit, wherein the fixed left-side equation comprises “Assets (A)+Expenses (E)+Contra-Liability (CL)+Contra-Equity (CEQ.)+Contra-Revenue (CR)”, wherein the fixed right-side equation comprises “Liabilities (L)+Owners' Equity (Eq.)+Revenues (R)+Contra-Asset (CA)+Contra-Expense (CE)”, determine if there is an issue associated with a data file by comparing a data file profile with the data file wherein the data file profile comprises historical information associated with the data file, transmit via the communication interface, one or more commands directing to execute an automated response for the issue associated with the data file, wherein a smart node is adapted to generate a smart node value, the smart node value is generated by accept the input and generate a list of reconciling possibilities associated with the issue if an issue is found, wherein the smart node is adapted to automatically assign a first smart node value of the first account category to a first spatial position within a single direction T-account, automatically assign a second smart node value of the second account category to a second spatial position within the single direction T-account wherein the first and second spatial positions of the single direction T-account comprises a left spatial position and a right spatial position, wherein the left spatial position is selected if the first smart node value is positive and the right spatial position is selected is the second smart node value is negative, wherein the left spatial position and the right spatial position of the single direction T-account correspond to the fixed left-side equation and the fixed right-side equation of the ENE, respectively. The list of reconciling possibilities are sorted in the order of most relevant option based on history file of transactions.

In one embodiment, the electronic device is a desktop, a laptop, or other similar computing device. The electronic device comprises a communication interface that allows for the sending and receiving of inputs and outputs. Additionally, the communication interface may also provide for wireless or wired communication. In one embodiment, the electronic device is in wireless communication via a communications network with a remote computing device or cloud network.

The computing platform is adapted to receive the data file, wherein the data files include information relating to an account transaction. This data file includes information such as the numerical value of the transaction, the association with an account category, the type of transaction and location of the numerical value entry in an accounting scheme, and the like.

In one embodiment, the computing platform looks to determine if there is an issue associated with the data file by comparing a data profile with the data file. The data profile may include similar characteristics, properties, attributes, and/or profiles associated with previously received data files. If the information of the data file is different than the information the expected to be received by the computing platform, then an issue may be detected and cause a smart node to generate a node value. In some instances, the data file profile may indicate previous historical information for the previous data files. The previous historical information may correspond to a data file size, content (e.g., transactions) associated with the previous data files, a time the previous data files were transmitted and/or received, parts of the previous data file (e.g., different sections, transactions, and/or topics), and/or priorities for different parts of the previous data file. For example, the previous historical information may indicate a time of the day, such as 2 PM ET, that previous data files associated with the user account were transmitted and/or received. Additionally, and/or alternatively, the previous historical information may indicate different parts and/or account categories for the previous data files.

In some embodiments, the smart node is adapted to generate a smart node value, which reflects the input of the data file received and/or generate a list of reconciling possibilities that is most likely associated with the data profile. The smart node assists with the collection and input of transaction into the correct account categories, including correcting signs, (positive/negative) of those inputs. The ENE is divided into particular categories (Assets (A)+Expenses (E)+Contra-Lability (CL)+Contra-Equity (CEQ.)+Contra-Revenue (CR)), each of which the account categories are labeled a debit or credit type, wherein an amount is positive if you are debiting a debit account. These categories follow a convention shown in a Chart of Accounts. The smart node interacts with the ENE by suggesting correct account categories and assisting with the correct vector information (positive/negative).

In some embodiment, the smart node is adapted to automatically assign a first smart node value of the first account category to a first spatial position within a single direction T-account and automatically assign a second smart node value of the second account category to a second spatial position within the single direction T-account. In this way, the smart node directly interacts with the ENE on an electronic device.

In one embodiment, the computing platform generates a warning if the smart node determines a non-balancing entry. For example, the warning can include a reconciliation entry suggesting a balancing account. The system stores previous entries posted to the account and shows the most likely transactions and accounts on the screen using machine learning technology. The machine learning technology can also pull information from the data file, the data file profile, and the historical information.

Tables 1, 2, and 3 below illustrate sample examples of suggested reconciliation entries. In Table 1, the user inputs a rent expense of $12,000. The platform suggests generated possibilities to complete recordation of the transaction. In Table 2, the user inputs an inventory purchase of $15,000. The corresponding entry are shown in the generated possibilities. In Table 3, the user records book product sales of $30,000. The corresponding entry are shown in the generated possibilities. Note, that the value includes a negative or positive value, and the position within the ENE, either ENE LEFT or ENE RIGHT. In this way, the platform keeps the desired position of the entry according to the principles described above.

TABLE 1
User Input

| | |
|---|---|
| (a) Rent Expense | $12,000 ENE LEFT |
| Generated Possibilities | Sorted output |
| (1) Cash | −12,000 ENE LEFT |
| (2) Accounts Payable | 12,000 ENE RIGHT |
| (3) Accrued liabilities | 12,000 ENE RIGHT |

TABLE 2
User Input

| | |
|---|---|
| (a) Inventory purchases | $15,000 ENE LEFT |
| Generated Possibilities | Sorted output |
| (1) Accounts Payable | 15,000 ENE RIGHT |
| (2) Cash | −15,000 ENE LEFT |
| (3) Cost of Goods Sold | −15,000 ENE LEFT |

TABLE 3
User Input

| | |
|---|---|
| (a) Book Product Sales | $30,000 ENE RIGHT |
| Generated Possibilities | Sorted output |
| (1) Accounts Receivables | $30,000 ENE LEFT |
| (2) Cash | $30,000 ENE LEFT |

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A system of accounting excluding debit and credit designations on a computing platform, comprising:
at least one processor;
an electronic device adapted to receive an input from a user and communicate an output to the user via a communication interface, the communication interface communicatively coupled to the at least one processor;
a non-transitory memory storing computer-readable instructions that, when executed by the at least one processor, cause the computing platform to:
receive a data file by the at least one processor, via the communication interface, wherein the data file comprises information related to an account transaction;
associate an account transaction with a first and second account category, wherein each account category corresponds to a variable of an expanded normal equation (ENE), wherein the ENE comprises a fixed left-side equation and a fixed right-side equation;
wherein the first and second account category exclude debit and credit;
wherein the fixed left-side equation comprises “Assets (A)+Expenses (E)+Contra-Liability (CL)+Contra-Equity (CEQ.)+Contra-Revenue (CR)”;
wherein the fixed right-side equation comprises “Liabilities (L)+Owners' Equity (Eq.)+Revenues (R)+Contra-Asset (CA)+Contra-Expense (CE)”;
determine if there is an issue associated with the data file by comparing a data file profile with the data file, wherein the data file profile comprises historical information associated with the data file;
transmit via the communication interface, one or more commands directing to execute an automated response for the issue associated with the data file;
wherein a smart node is adapted to generate a smart node value, the smart node value is generated by accepting the input and generating a list of reconciling possibilities associated with the issue if an issue is found;
wherein the smart node is adapted to automatically assign a first smart node value of the first account category to a first spatial position within a single direction T-account;
automatically assign a second smart node value of the second account category to a second spatial position within the single direction T-account;
wherein the first and second spatial positions of the single direction T-account comprises a left spatial position and a right spatial position, wherein the left spatial position is selected if the first smart node value is positive and the right spatial position is selected is the second smart node value is negative;
wherein the left spatial position and the right spatial position of the single direction T-account correspond to the fixed left-side equation and the fixed right-side equation of the ENE, respectively.

2. The computing platform of claim 1, wherein instructions stored on the non-transitory memory, when executed by the at least one processor, cause the computing platform to:
automatically input the first smart node value of the first spatial position or the second smart node value of the second spatial position into the ENE, respectively;
automatically calculate the ENE after the first and second smart node values are received so as to check that the left-side equation with the right-side equation is balanced.

3. The computing platform of claim 2, wherein instructions stored on the non-transitory memory, when executed by the at least one processor, cause the computing platform to:
generate a warning if the smart node determines a non-balancing entry.

4. The computing platform of claim 3, wherein the generated list of reconciling possibilities utilizes machine learning technology from the data file and data file profile.

5. The computing platform of claim 4, wherein the single direction T-account comprising:
vertical dividing element and a horizontal dividing element at an upper end thereof forming a “T” shape;
wherein a left side and right side is formed on opposing sides of the vertical dividing element;
each side comprising a positive sign or a negative side.

6. The system of claim 1, wherein the left side of the single direction T-account comprises the positive sign and the right side of the single direction T-account comprises the negative sign.

7. The system of claim 1, wherein account transaction information includes account and amount.

8. The system of claim 1, wherein the account information includes Variable, Account Number, Type, Initial Balance, and Account Description.

9. The system of claim 1, wherein the first and second account are selected from assets, liabilities, equity, revenues, and expenses.

10. The system of claim 1, wherein the non-transitory memory storage is disposed on the electronic computer.
